(19) United States
(12) Patent Application Publication
(10) Pub. No.: US 2006/0077286 A1
(43) Pub. Date: Apr. 13, 2006

(54) Video camera support assembly

(76) Inventor: Gregory J. Wenderski, Springdale, AR (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/247,310

(22) Filed: Oct. 11, 2005

Related U.S. Application Data
(60) Provisional application No. 60/617,013, filed on Oct. 8, 2004.

(51) Int. Cl. H04N 5/225

(52) U.S. Cl. 348/373

(57) ABSTRACT

A video camera support assembly includes a platform and a flexible neck. The platform defines a substantially planar surface. The flexible neck extends from the substantially planar surface of the platform and is configured to receive and be selectively coupled with a video camera on a first end opposite the platform. The flexible neck is adjustable to vary the position of the video camera.

### CROSS-REFERENCE TO RELATED APPLICATIONS

This patent application claims priority to U.S. Provisional Patent Application Ser. No. 60/617,013, filed Oct. 8, 2004, and incorporated herein by reference.

### BACKGROUND

The use of video imagers in classrooms, courtrooms, etc. has become increasingly important in the passing years. One such imaging apparatus is a camera-assisted presentation system including a video camera and displaying an image of a subject on a video monitor or via a video projector. In particular, such an imaging apparatus includes a platform on which the subject, such as a document or a photograph, is placed or mounted and a video camera located above a center portion of the platform. The video camera is typically attached to a post, which is fixed to the platform. During use, items can be selectively placed on the platform where their image is captured by the video camera and electrically forwarded to a video projector or video monitor for viewing by a larger audience. Use of the video imager, thereby, allows a relatively large audience to view smaller complicated subjects.

Conventional video imagers, however, are typically fully integrated apparatuses in which the video camera and any light source apparatus are fully integrated with the platform. In addition, the platform typically includes the plurality of controls for the video camera and a surface light source for backlighting the subject when placed on the platform. This full integration and feature presentation provides for an able but relatively expensive imaging apparatus. Furthermore, the integrated nature of the conventional imaging apparatus complicates replacement of any given component of the imaging apparatus upon failure or need for upgrade. In addition, the light source of typical imaging apparatus requires particular bulbs not readily available through normal consumer channels.

Moreover, the integrated image apparatus is a relatively expensive machine, thereby, limiting the availability of the imaging apparatus to relatively lower budget entities. Furthermore, the bulk of the imaging apparatus, even in a typical foldable version, requires a relatively large storage area to maintain the imaging apparatus during periods of non-use and protect the imaging apparatus from theft.

For the reasons stated above, an imaging apparatus is desired that provides a non-integrated camera allowing for ease of storage at a relatively inexpensive cost to increase accessibility to all consumers.

### SUMMARY

One aspect of the present invention relates to a video camera support assembly. The video camera support assembly includes a platform and a flexible neck. The platform defines a substantially planar surface. The flexible neck extends from the substantially planar surface of the platform and is configured to receive and be selectively coupled with a video camera on a first end opposite the platform. The flexible neck is adjustable to vary the position of the video camera.

### BRIEF DESCRIPTION OF THE DRAWINGS

Embodiments of the invention are better understood with reference to the following drawings. Elements of the drawings are not necessarily to scale relative to each other. Like reference numerals designate corresponding similar parts.

FIG. 1 is a perspective view of one embodiment of a video imager having a video camera support assembly and camera.

FIG. 2 is a bottom, perspective view of a platform of the video camera support assembly of FIG. 1.

FIG. 3 is a perspective view of a portion of the video camera support assembly of FIG. 1.

FIG. 4 is a perspective view of one embodiment of a video imager having a video camera support assembly and camera.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

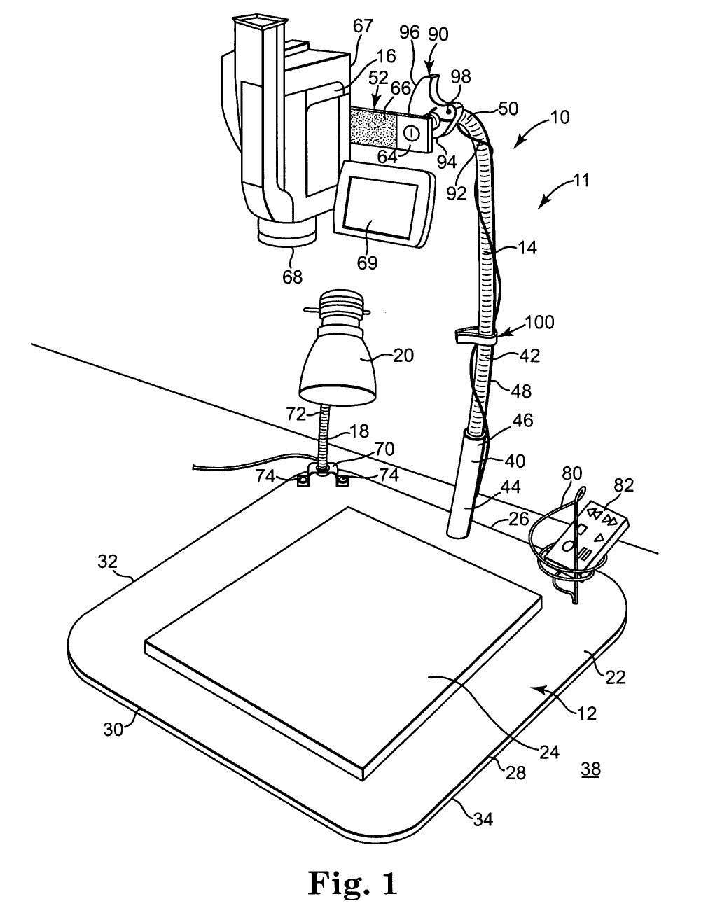

FIG. 1 illustrates one example embodiment of a video imager 10 according to the present invention. Video imager 10 includes a video imaging platform or a video camera support assembly 11 and a video capture device, such as a camera 16. Video camera support assembly 11 includes a base or platform 12, a camera support neck 14, a light support neck 18, and a light source 20. Platform 12 includes a top surface 22 for supporting a subject 24. In one embodiment, top surface 22 is substantially planar. In one embodiment, platform 12 is coupled with or is integrated into a table, cart, podium, etc.

Camera support neck 14 extends from top surface 22 of platform 12. Camera 16 is attached to camera support neck 14 opposite platform top surface 22. In one embodiment, camera support neck 14 initially extends from platform 12 with a substantially perpendicular orientation. Camera support neck 14 is adjustable such that camera 16 can be positioned directly above subject 24 to capture an image of at least a portion of subject 24. Camera support neck 14 extends from any suitable position of top surface 22. In one embodiment, camera support neck 14 is positioned near an edge of platform 12. For example, camera support neck 14 optionally is centered or off-centered along a particular edge of platform 12.

Light support neck 18 also extends from top surface 22 of platform 12. Light source 20 is coupled to light support neck 18 opposite platform 12 and is directed toward subject 24 to illuminate subject 24 to improve the quality of the image captured by camera 16. In one embodiment, light support neck 18 and camera support neck 14 each extend from top surface 22 near the same edge of platform 12.

In one embodiment, platform 12 additionally defines, a first side 26, a second side 28, a third side 30, a fourth side 32, and a bottom surface 34 opposite top surface 22. Third side 30 is opposite first side 26, and second and fourth sides 28 and 32 extend between first and third sides 26 and 30 opposite one another. To this end, sides 26, 28, 30, and 32 collectively extend around the perimeter of top and bottom surfaces 22 and 34. Both top and bottom surfaces 22 and 34 are substantially planar to provide stable interaction between video imager 10 and a table or support surface 38 on which video imager 10 is placed.

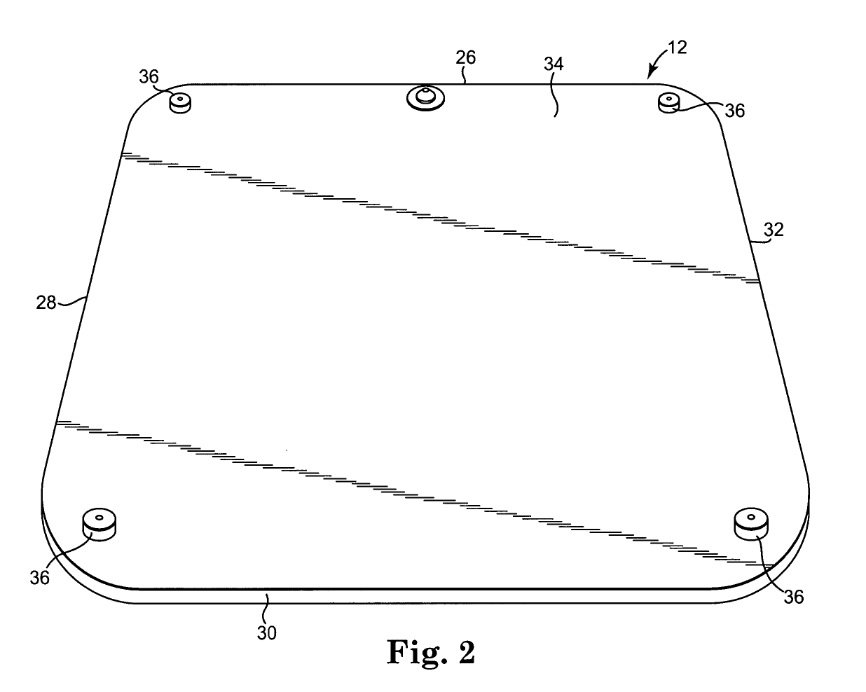

FIG. 2 illustrates a bottom perspective view of platform 12. In one embodiment, platform 12 includes a plurality of rubber or other skid resistant feet 36 extending from the bottom surface 34 opposite top surface 22. In one embodiment, a skid resistant foot 36 is placed in each corner of bottom surface 34. During use, each skid resistant foot 36 interacts with support surface 38 (illustrated in FIG. 1) to selectively maintain the position of video imager 10 upon support surface 38 and to decrease or prevent inadvertent movement of video imager 10 with respect to support surface 38. Platform 12 is a substantially rigid piece of material. In one embodiment, platform 12 is formed of a plastic, wood, metal, composite, or laminated material sufficiently rigid for supporting video imager 10 and subject 24. In addition, platform 12 is sized and shaped to sufficiently balance the weight of camera support neck 14, camera 16, light support neck 18 and light source 20 to prevent instability of video imager 10. Although described and illustrated as being substantially rectangular, in one embodiment, platform 12 has a shape that is one of a substantially circular, oval, polygonal, etc. Notably, in one embodiment, platform 12 is characterized by the absence of electronic controls for camera 16 and/or for light source 20.

Once again referring to FIG. 1, in one embodiment, camera support neck 14 extends from top surface 22 in a direction opposite bottom surface 34. In one embodiment, camera support neck 14 is positioned relatively near to first side 26 of platform 12 and is substantially centered between second and fourth sides 28 and 32 of platform 12. In one embodiment, camera support neck 14 includes a substantially rigid tubular or cylindrical portion 40 and a flexible portion 42. Rigid portion 40 includes a first end 44 and a second end 46 opposite first end 44. First end 44 is adjacent top surface 22 of platform 12. In one embodiment, first end 44 is coupled to platform 12 by a bolt, rivet, or other connection. In one embodiment, rigid portion 40 extends from first end 44 in a substantially vertical manner (i.e. perpendicular to top surface 22).

Flexible portion 42 also includes a first end 48 and a second end 50 opposite first end 48. First end 48 of flexible portion 42 is coupled to second end 46 of rigid portion 40. Camera support neck 14 is sized to provide camera 16 with the adjustability desired by the user. In one embodiment, rigid portion 40 is about 6 inches long and flexible portion 42 is about 20 inches long. The flexible or gooseneck nature of flexible portion 42 allows camera support neck 14 to be adjusted to alter the height and/or orientation of second end 50 relative to platform 12. In one embodiment, flexible portion 42 is positioned such that camera support neck 14 is adjustable along an internal portion of camera support neck spaced from platform 12 and camera 16.

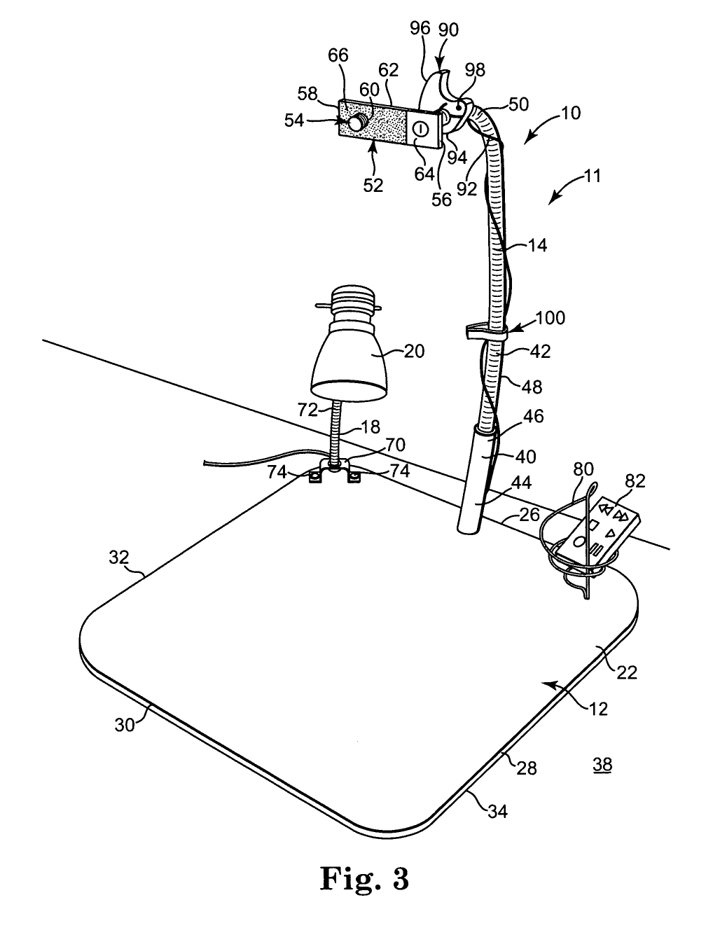

In one embodiment, at second end 50, camera support neck 14 additionally includes a connection plate 52 and a connection device 54, which is illustrated with additional reference to FIG. 3. Connection plate 52 is a rectangular or elongated plate defining a first side 56, a second side 58 opposite first side 56, a first surface 62, and a second surface 64 opposite first surface 62. In one embodiment, second end 50 of flexible portion 42 is coupled with connection plate 52 relatively near first side 56, such as with a bolt, screw, weld or other fastener, to extend from the first surface 62 of connection plate 52. In one embodiment, connection plate 52 is removably coupled with flexible portion 42 with a bolt, screw, or other connection device or integral mechanism.

Connection plate 52 defines an aperture 60 relatively near second side 58 of connection plate 52. Aperture 60 extends entirely through connection plate 52. Connection device 54, such as a bolt or a screw, extends through aperture 60 to interface with camera 16 (illustrated in FIG. 1). In one embodiment, connection plate 52 includes a pad 66 extending over at least a portion of second surface 64 around aperture 60. Pad 66 cushions the interface between connection plate 52 and camera 16. In one embodiment, another pad similar to pad 66 extends over at least a portion of first surface 62.

In one embodiment, camera 16 is any video camera capable of capturing an image and conveying that image to a remote video monitor or remote video projector (not illustrated), such as a CCD projector or video monitor connected to camera 16 via an S-video cable or other video cable. In one embodiment, camera 16 is a digital video camera including multiple features, such as zoom or magnification, color record, black and white record, pause, record, playback, time lapse record, auto-focus, low-light infrared imaging, etc. In one example, camera 16 is video camera adapted for hand-held use.

In one embodiment, camera 16 includes a display screen 69, such as an LCD display screen, that allows a user to view the images being captured by camera 16 during use. In one embodiment, camera 16 is configured to receive a data storage device, such as a magnetic recording tape, a DVD, a CD, a hard disk, etc. for storing images captured by camera 16. In one embodiment, camera 16 is coupled to one of a viewing screen or monitor with wires or cables 92 or other cords as will be apparent to those of skill in the art. In one example, images captured by camera 16 are stored to the data storage device at the same time they are forwarded to a remote monitor or projector for viewing.

A bottom 67 of camera 16 includes a connection cavity (not shown) for selective coupling with camera support neck 14. More specifically, as illustrated in FIG. 1, bottom 67 of camera 16 is positioned adjacent to second surface 64 of connection plate 52 and connection device 54 extends through connection plate 52 and into the aperture of camera 16. In one embodiment, the connection cavity of camera 16 is a threaded cavity adapted to selectively receive the connection device 54. In one example, while coupled with connection plate 52, camera 16 is not adjustable relative to second end 50 of camera support neck 14. In one embodiment, upon attachment of camera 16 to connection plate 52, camera 16 is positioned such that its lens 68 is generally directed toward platform 12, more particularly, toward subject 24 resting upon platform 12.

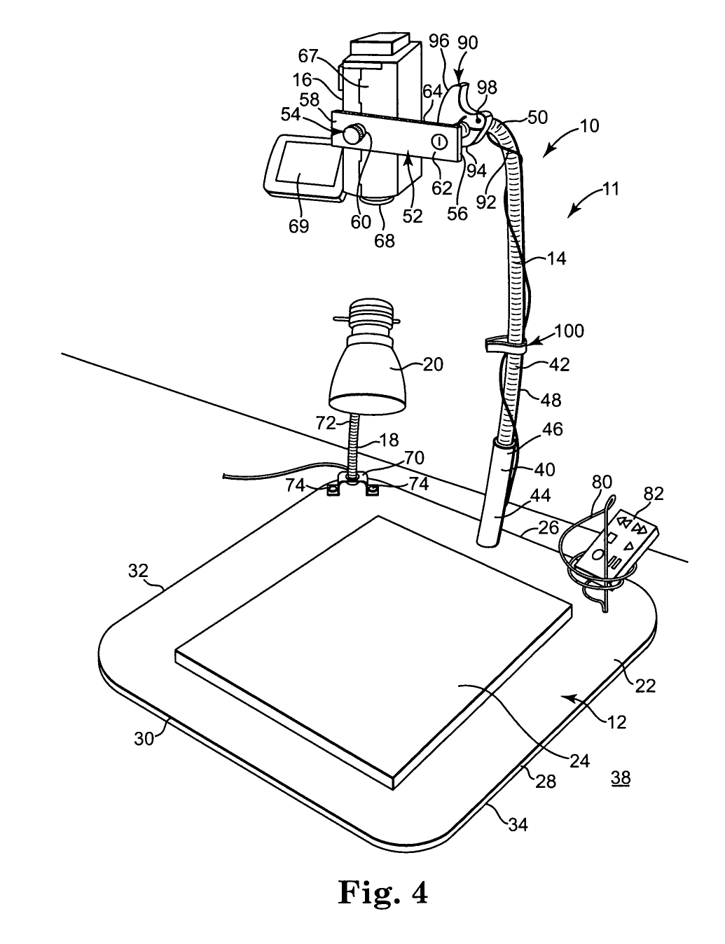

In one embodiment, as illustrated in FIG. 4, connection plate 52 is mounted on flexible portion 42 of camera support neck 14 in a similar manner as described above except that connection plate 52 is flipped relative to camera support neck 14. As such, flexible portion 42 extends from second surface 64, rather than first surface 62, of connection plate 52. As such, camera 16 and flexible portion 42 are each attached to second surface 64 of connection plate 52. In one embodiment in which a pad 66 (illustrated in FIG. 3) is included on each side of connection plate 52, connection pate 52 is coupled with camera support neck 14 along first surface 62, and camera 16 is adapted to be coupled with connection plate 52 along either one of first surface 62 and second surface 64. In one embodiment, flexible portion 42 is coupled with one of first or second surfaces 62 and 64 of connection plate 52 as selected to orientate camera 16 as desired to capture images of subject 24 with a desired orientation.

As illustrated in FIGS. 1 and 3, light support neck 18 is coupled to platform 12 and extends from top surface 22 of platform 12 in at least a partially upward manner. In one embodiment, light support neck 18 includes a bracket 70 and a flexible elongated portion 72 extending from bracket 70. Bracket 70 is coupled with top surface 22 of platform 12 via connection screws or other connection device 74. In one embodiment, bracket 70 is coupled to platform 12 at a corner or near an area of interaction between first side 26 and fourth side 32 of platform 12. In this manner, light support neck 18 is preferably spaced upon platform 12 from camera support neck 14.

Flexible portion 72 has gooseneck or flexible characteristics, which allow the height, angle, orientation, etc. of light source 20 relative to platform 12 to be selectively adjusted. Flexible portion 72 is sized to provide light source 20 with the adjustability desired by the user. In one embodiment, flexible portion 72 is about 14 inches long. Light source 20 is coupled to flexible portion 72 opposite bracket 70. In one embodiment, light source 20 is any light source commercially available. In one embodiment, light source 20 includes one of an incandescent light bulb and a florescent light bulb (not illustrated). In one embodiment, light support neck 18 can be adjusted to change the orientation of light source 20 by up to 360° in three or more directions, such as (1) up and down; (2) side to side; and (3) front to back.

In one embodiment, video camera support assembly 11 additionally includes a utensil holder 80. In one embodiment, utensil holder 80 is coupled to platform 12 near the intersection of first side 26 and second side 28. Utensil holder 80 provides a place for collecting and selectively maintaining utensils used with video imager 10, such as a remote control 82 associated with camera 16 or with the display device and any writing utensils, cutting utensils, gluing utensils, etc. (not illustrated) used with video imager 10. Remote control 82 is associated with camera 16 for remotely activating the options and characteristics of camera 16 during use. In one embodiment, utensil holder 80 is formed as a single twisted metal piece capable of holding the remote control 82 and/or other utensils. In one embodiment, utensil holder 80 is formed to represent a symbol, such as a trademark or other identifier of the manufacturer of video camera support assembly 11. In one embodiment, utensil holder 80 is any other suitable utensil holder, such as a mesh cup or desktop organizer.

During use, subject 24 (illustrated in FIG. 1) is placed upon top surface 22 of platform 12. Notably, due to the simple and relatively inexpensive nature of platform 12, multiple types of subjects 24 can be placed upon platform 12 without concern of permanent damage to platform assembly 12. In particular, subject 24 may include a piece of paper, a transparency, a book, an experiment, a show-and-tell item, or any other 2-D or 3-D item desired to be captured by camera 16. In one embodiment, multiple subjects 24 are placed upon platform 12 at one time. Adjustment of flexible portion 42 of camera support neck 14 adjusts the position, angle, and orientation of camera 16 relative to platform 12, and therefore, relative to subject 24 positioned upon platform 12. In particular, camera support neck 14 is adjusted to direct camera 16 toward subject 24 in a manner allowing camera 16 to capture an image of the desired portion of subject 24.

Similarly, light source 20 is activated, as needed, to provide illumination to subject 24. In one embodiment, flexible portion 72 of light support neck 18 is also adjusted in order to provide light source 20 with a proper distance, angle, and orientation relative to subject 24 to improve the image of subject 24 captured by camera 16. In one embodiment, the characteristics or options of camera 16 are similarly adjusted, either on camera 16 or by remote control 82, in order to capture the portion of subject 24 as desired by the user.

In one embodiment, camera 16 electronically communicates with a remote viewing screen or monitor (not illustrated) via wires or cables 92 to display the image captured by camera 16 on the viewing screen or monitor to facilitate group viewing of subject 24 and/or to act as a magnification tool for viewing subject 24. Notably, during use, subject 24 can be removed and or replaced with other subjects 24. Additionally, camera 16 and support necks 14 and 18 can be periodically and selectively adjusted during use as desired by a user. In one embodiment, camera support neck 14 can be adjusted to change the orientation of camera 16 by up to 360° in three or more directions, such as (1) up and down; (2) side to side; and (3) front to back. In one embodiment, the options and characteristics of camera 16 can be periodically adjusted during use to vary the portion of subject(s) 24 captured as an image.

In one embodiment, support necks 14 and 18 can be adjusted to capture a subject near video imager 10 but not positioned upon platform 12, such as a presenter or other object(s) too large or not sufficiently mobile to be placed upon platform 12. In one embodiment, a user can easily and selectively access utensils, such as remote control 82, from utensil holder 80 for use with video imager 10 throughout use of video imager 10 and replace utensils within utensil holder 80 during periods of utensil non-use.

Notably, the relatively inexpensive and rather robust nature of video imager 10 also allows video imager 10 to be utilized by multiple types of users, including small children and other individuals that would not otherwise be granted access to a conventional video imager due to concerns of permanent damage to the relatively expensive and cumbersome conventional video imagers.

Moreover, following use of video imager 10, camera 16 is easily detachable from camera support neck 14. In particular, loosening of connector 54 releases camera 16 with respect to plate 52. Once removed from camera support neck 14, camera 16 can be used as a hand-held camera, used within another video imager 10, and/or securely stored to prevent theft of camera 16, which commonly is the most expensive component of video imager 10. The selective couplability of the camera 16 to camera support neck 14 of video camera support assembly 11 also allows video imager 10 to be easily upgraded or customized for particular use merely by replacing or exchanging various cameras 16 upon camera support neck 14 wherein each camera 16 has different combinations of capabilities, options, and characteristics available for use.

In one embodiment, as illustrated in FIG. 1, attachment and detachment of camera 16 to and from camera support neck 14 is further facilitated by use of a clamp 90. More specifically, clamp 90 extends around flexible portion 42 to maintain any wiring or cables 92 or other electrical cords extending from electrical or signal sources up flexible portion 42 to interface with camera 16. Electrical cord 92 is any power or video wiring or cable. In one embodiment, electrical cord is one of an output cord to a display device, a power input cord, a computer interface cord, such as a firewire or USB cable, or any other suitable electrical cord adapted to interface with camera 16. Although illustrated as a single cord 92, it should be understood that a plurality of cords may similarly be included and maintained by clamp 90.

In one embodiment, clamp 90 is positioned near second end 50 of camera support neck 14 to hold cables 92 in position with respect to flexible portion 42 near attachment plate 52. By maintaining the cables or wiring 92 near attachment plate 52, even when detached from camera 16, cables and wiring 92 are maintained in the position easily accessible for reattachment to camera 16. In addition, by maintaining wiring or cables 92 relatively near camera support neck 14, wiring or cables 92 are less likely to obstruct or interfere with the view of subject 24 by camera 16 during use.

In one embodiment, clamp 90 is a cable clamp including a first portion 94 and a second portion 96 rotatably coupled to one another about an axis 98. Accordingly, first portion 94 and second portion 96 interact in a jaw-like fashion and are biased towards one another opposite axis 98. During use, second portion 96 is rotated away from first portion 94 about axis 98 to open clamp 90 to receive cables or wiring 92 and camera support neck 14. Second portion 96 is released and, due to the biasing of clamp 90, first and second portions 94 and 96 press towards one another thereby clamping or holding cable or wiring 92 to camera support neck 14. In one embodiment, other clamps or mechanisms for maintaining cable or wiring 92 with respect to camera support neck 14 are used as an alternative to clamp 90.

In one embodiment, a second clamp 100 similar to clamp 90 is placed to maintain cables or wiring 92 with respect to camera support neck 14. For example, second clamp 100 is spaced from first clamp 90, and as such, second clamp 100 is positioned nearer first end 48 of flexible portion 42 of the camera support neck 14. Second clamp 100 functions similar to first clamp 90 to selectively maintain cables or wiring 92 near camera support neck 14 to decrease the occurrence of cable or wiring 92 interference with use of camera 16 to capture subject 24 during use. In one embodiment, alternate clamps or other mechanisms are used to maintain cables or wiring 92 with respect to camera support neck 14 nearer platform 12 than camera connection plate 52. With the above in mind, clamps 90 and/or 100 collectively maintain cables or wiring 92 with respect to camera support neck 14 even when camera 16 is detached from video imager platform 11. Cables or wiring 92 are thereby maintained for subsequent attachment of camera 16 in a position allowing for ease of reattachment as well as reducing the time needed for reattachment of camera 16 to video camera support assembly 11.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A video camera support assembly, comprising:
a platform defining a substantially planar surface; and
a flexible neck extending from the substantially planar surface of the platform and being configured to receive and be selectively coupled with a video camera on a first end opposite the platform, wherein the flexible neck is adjustable to vary the position of the video camera.

2. The video camera support assembly of claim 1, wherein the flexible neck is adjustable along a neck portion spaced from each of the platform and the first end of the flexible neck.

3. The video camera support assembly of claim 1, wherein the flexible neck includes a gooseneck portion.

4. The video camera support assembly of claim 1, wherein the substantially planar surface is configured to support a subject to be photographed with the video camera.

5. The video camera support assembly of claim 1, wherein the flexible neck is adjustable in at least three directions.

6. The video camera support assembly of claim 1, wherein an elongated connection plate is coupled to the first end of the flexible neck to facilitate coupling of the video camera to the flexible neck.

7. The video camera support assembly of claim 1, wherein the connection plate defines a first surface and a second surface opposite the first surface, the connection plate interfacing with the flexible neck at one of the first surface and the second surface, and wherein the first surface is configured to be coupled with the camera.

8. The video camera support assembly of claim 1, further comprising:
a light source;
a light support neck extending from the platform and defining a first end opposite the platform, the first end of the light support neck being coupled with the light source, wherein the light support neck is adjustable to position the light source to illuminate a subject being photographed with the video camera.

9. The video camera support assembly of claim 1, wherein the light support neck includes a flexible portion adjustable in at least three directions.

10. The video camera support assembly of claim 1, wherein the light support neck is coupled to the planar surface of the platform.

11. The video camera support assembly of claim 1, further comprising:
at least one cord selectively couplable to the video camera; and
at least one clamp configured to maintain the cord near to the flexible neck.

12. The video camera support assembly of claim 1, further comprising:
a utensil holder coupled to the platform and configured to selectively maintain one or more utensils.

13. The video camera support assembly of claim 1, in combination with a video camera coupled to the flexible neck and adapted to capture video images of a subject and to record the video images to a data storage device maintained by the video camera.

14. A video imager, comprising:
a platform;
a video capture device; and
a support neck extending from the platform and coupled with the video capture device opposite the platform, the support neck including a flexible portion spaced from the platform and the video capture device, the flexible portion being adjustable to vary the position of the video capture device relative to the platform.

15. The video imager of claim 14, wherein while coupled to support neck, the video capture device is maintained in a substantially stationary position relative to an end of the support neck opposite the platform.

16. The video imager of claim 14, wherein the video capture device is configured to be coupled to the support neck in each of two positions, and wherein each of the two positions correspond to one of two orientations of the video capture device.

17. The video imager of claim 14, wherein the video capture device is configured to selectively receive a data recording device and to record video of a subject to the data recording device.

18. The video imager of claim 14, wherein the video capture device includes a display screen.

19. A method of capturing video of a subject, the method comprising:
providing a support assembly including a platform and a support arm, the support arm including a first end coupled to the platform, a second end opposite the first end, and a flexible portion extending at least partially between the first end and the second end;
coupling a video capture device to the second end of the support arm;
positioning the video capture device relative to the subject by bending the flexible portion of the support arm until the video capture device is positioned to capture video of the subject, wherein the subject is positioned at one of on the platform and spaced from the platform; and
capturing video images of the subject and forwarding such images to one of a video projector and a video display screen coupled with the video capture device.

20. The method of claim 19, further comprising:
removing the video capture device from the support arm; and
capturing additional video images while the video camera is removed from the support arm.
